(19) United States
(12) Patent Application Publication
(10) Pub. No.: US 2016/0373648 A1
(43) Pub. Date: Dec. 22, 2016

(54) METHODS AND SYSTEMS FOR CAPTURING FRAMES BASED ON DEVICE INFORMATION

(71) Applicant: HTC CORPORATION, TAOYUAN CITY (TW)

(72) Inventors: Fu-Chang TSENG, Taoyuan City (TW); Jing-Lung WU, Taoyuan City (TW); Hsin-Ti CHUEH, Taoyuan City (TW)

(21) Appl. No.: 14/743,245

(22) Filed: Jun. 18, 2015

(51) Int. Cl. H04N 5/232

(52) U.S. Cl. CPC H04N 5/23229; H04N 5/23216

(57) ABSTRACT

Methods and systems for capturing frames based on device information are provided. First, device information is obtained from at least one component of an electronic device. A configuration for an image capture unit is adjusted according to the device information, to obtain at least one adjusted configuration. Then, at least one frame is captured via the image capture unit according to the at least one adjusted configuration.

### BACKGROUND OF THE INVENTION

### Field of the Invention

The disclosure relates generally to methods and systems for capturing frames, and, more particularly to methods and systems for capturing frames based on device information of an electronic device.

### Description of the Related Art

Recently, portable devices, such as handheld devices, have become more and more technically advanced and multifunctional. For example, a handheld device may have telecommunications capabilities, e-mail message capabilities, image capture capabilities, an advanced address book management system, a media playback system, and various other functions. Due to increased convenience and functions of the devices, these devices have become necessities of life.

As described, a handheld device may have image capture capabilities. Generally, during an image capture process, an image system can automatically detect an environment condition, such as the light and/or weather situation of a current environment, set a proper configuration of an image sensor, and capture an image frame based on the configuration.

However, in some cases, the imaging system may not cover all environment conditions. In other words, the image frames captured at various environment conditions may not meet user's expectation.

### BRIEF SUMMARY OF THE INVENTION

Methods and systems for capturing frames based on device information are provided.

In an embodiment of a method for capturing frames based on device information, device information is obtained from at least one component of an electronic device. A configuration for an image capture unit is adjusted according to the device information, to obtain at least one adjusted configuration. Then, at least one frame is captured via the image capture unit according to the at least one adjusted configuration.

An embodiment of a system for capturing frames based on device information comprises at least one component of an electronic device, an image capture unit having a configuration, and a processing unit. The processing unit obtains device information from the at least one component, and adjusts the configuration according to the device information, to obtain at least one adjusted configuration. The processing unit enables the image capture unit to capture at least one frame according to the at least one adjusted configuration.

In some embodiments, the at least one frame can be further combined to obtain an image.

In some embodiments, the configuration is preset by the image capture unit according to a current environment condition.

In some embodiments, the component comprises a positioning unit, a motion sensor, and/or a timer of the electronic device.

In some embodiments, the configuration comprises settings for a gain value, an exposure value, a shutter value, an aperture value, a white balance, an ISO value, an optical or digital zoom effect, a timing for capturing, and/or a delay period for capturing.

Methods for capturing frames based on device information may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for capturing frames based on device information of the invention;

FIG. 2 is a flowchart of an embodiment of a method for capturing frames based on device information of the invention;

FIG. 3 is a flowchart of another embodiment of a method for capturing frames based on device information of the invention; and

FIG. 4 is a flowchart of another embodiment of a method for capturing frames based on device information of the invention;

### DETAILED DESCRIPTION OF THE INVENTION

Methods and systems for capturing frames based on device information are provided.

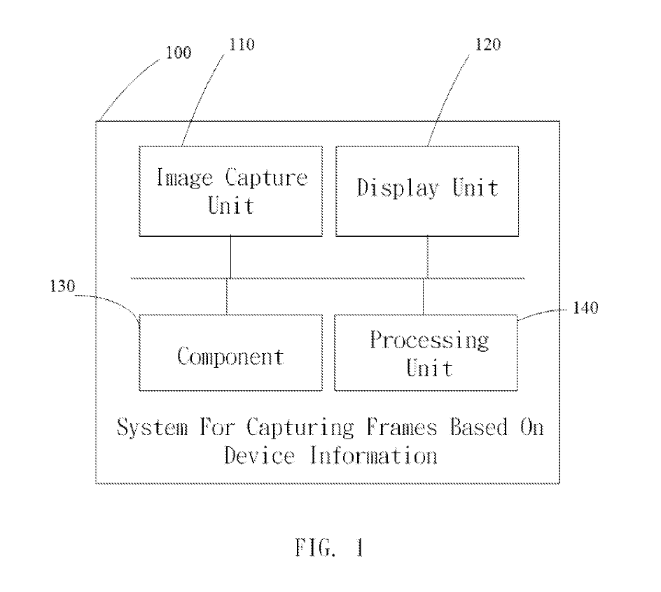

FIG. 1 is a schematic diagram illustrating an embodiment of a system for capturing frames based on device information of the invention. The system for capturing frames based on device information 100 can be used in an electronic device, such as a computer, or a portable device, such as a digital camera, a handheld device such as a mobile phone, a smart phone, a PDA (Personal Digital Assistant), a GPS (Global Positioning System), or any picture-taking device.

The system for capturing frames based on device information 100 comprises an image capture unit 110, a display unit 120, at least one component 130, and a processing unit 140. The image capture unit 110 may be a CCD (Charge Coupled Device) or a CMOS (Complementary Metal-Oxide Semiconductor), placed at the imaging position for objects inside the electronic device. The image capture unit 110 can capture frames based on a configuration, which can be determined according to a current environment condition detected by the image capture unit 110. It is understood that, in some embodiments, the configuration can comprise settings for a gain value, an exposure value, a shutter value, an aperture value, a white balance, an ISO value, an optical or digital zoom effect, a timing for capturing, and/or a delay period for capturing. It is noted that, the above configurations are only examples of the present application, and the present invention is not limited thereto. The display unit 120 can display related figures and interfaces, and related data, such as the image frames captured by the image capture unit 110. It is understood that, in some embodiments, the display unit 120 may be a screen integrated with a touch-sensitive device (not shown). The touch-sensitive device has a touch-sensitive surface comprising sensors in at least one dimension to detect contact and movement of an input tool, such as a stylus or finger on the touch-sensitive surface. That is, users can directly input related data via the display unit 120. It is understood that, the image data captured by the image capture unit 110 can be permanently or temporarily stored in a storage unit, which may be a built-in memory, or an external memory card of the system for capturing frames based on device information 100. The at least one component 140 may output device information for adjusting the configuration of the image capture unit 110. It is understood that, in some embodiments, the component can comprise a positioning unit, such as a GPS unit, a motion sensor, and/or a timer of the electronic device. It is noted that, the motion sensor may be an accelerometer and/or a Gyro sensor for detecting the movement of the electronic device. It is noted that, the above components are only examples of the present application, and the present invention is not limited thereto. The processing unit 140 can control related hardware and software components of the system for capturing frames based on device information 100, process the image frames captured by the image capture unit 110, and perform the methods for capturing frames based on device information of the invention, which will be discussed further in the following paragraphs. It is noted that, the system for capturing frames based on device information 100 can further comprise a focus unit (not shown in FIG. 1). The processing unit 140 can control the focus unit to perform a focus process for at least one object during the image capture process.

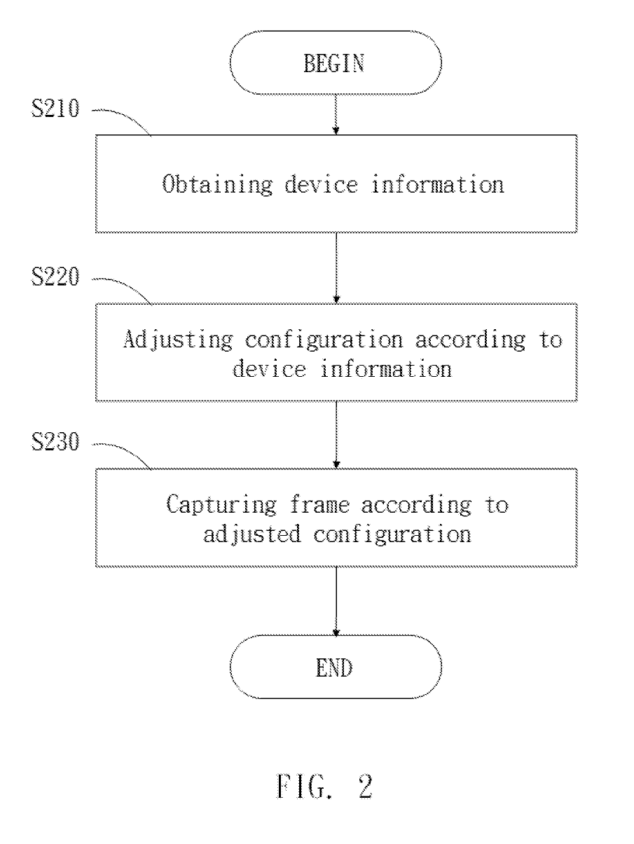

FIG. 2 is a flowchart of an embodiment of a method for capturing frames based on device information of the invention. The method for capturing frames based on device information can be used in an electronic device, such as a computer, or a portable device, such as a digital camera, a handheld device such as a mobile phone, a smart phone, a PDA, a GPS, or any picture-taking device.

In step S210, device information is obtained from at least one component of an electronic device. It is understood that, in some embodiments, the component can comprise a positioning unit, such as a GPS unit, a motion sensor, and/or a timer of the electronic device. It is noted that, the above components are only examples of the present application, and the present invention is not limited thereto. In step S220, a configuration for an image capture unit is adjusted according to the device information, to obtain an adjusted configuration. It is understood that, in some embodiments, the configuration can comprise settings for a gain value, an exposure value, a shutter value, an aperture value, a white balance, an ISO value, an optical or digital zoom effect, a timing for capturing, and/or a delay period for capturing. It is noted that, the above configurations are only examples of the present application, and the present invention is not limited thereto. Then, in step S230, a frame is captured via the image capture unit according to the at least one adjusted configuration.

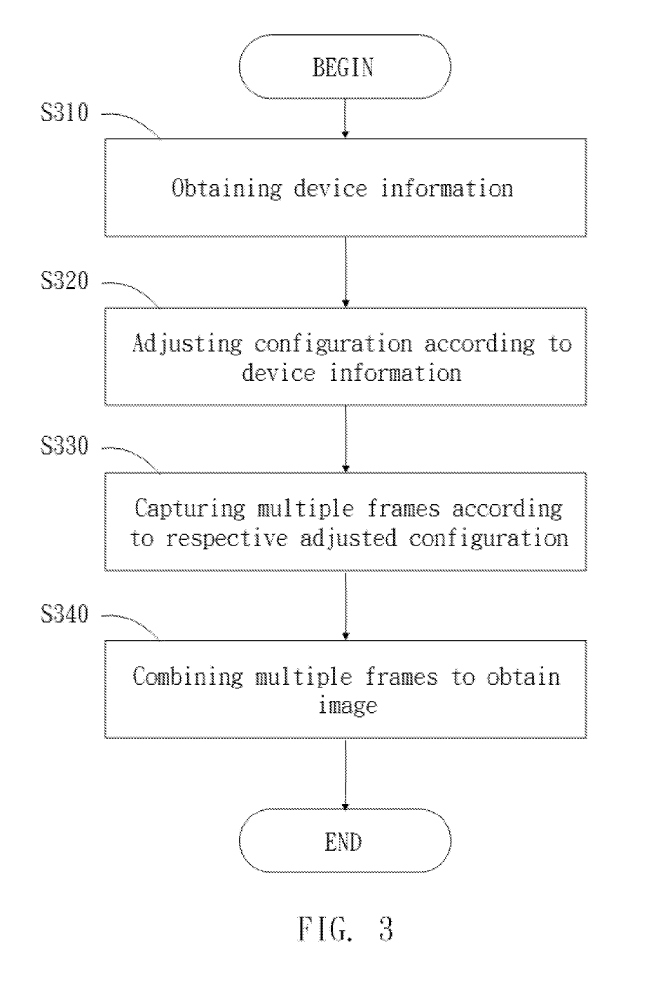

FIG. 3 is a flowchart of another embodiment of a method for capturing frames based on device information of the invention. The method for capturing frames based on device information can be used in an electronic device, such as a computer, or a portable device, such as a digital camera, a handheld device such as a mobile phone, a smart phone, a PDA, a GPS, or any picture-taking device. In the embodiment, multiple frames can be captured.

In step S310, device information is obtained from at least one component of an electronic device. Similarly, in some embodiments, the component can comprise a positioning unit, such as a GPS unit, a motion sensor, and/or a timer of the electronic device. It is noted that, the above components are only examples of the present application, and the present invention is not limited thereto. In step S320, a configuration for an image capture unit is adjusted according to the device information, to obtain multiple adjusted configurations. Similarly, in some embodiments, the configuration can comprise settings for a gain value, an exposure value, a shutter value, an aperture value, a white balance, an ISO value, an optical or digital zoom effect, a timing for capturing, and/or a delay period for capturing. It is noted that, the above configurations are only examples of the present application, and the present invention is not limited thereto. Then, in step S330, multiple frames are captured via the image capture unit according to the respective adjusted configurations. After the frames are captured, in step S340, the multiple frames are combined to obtain an image.

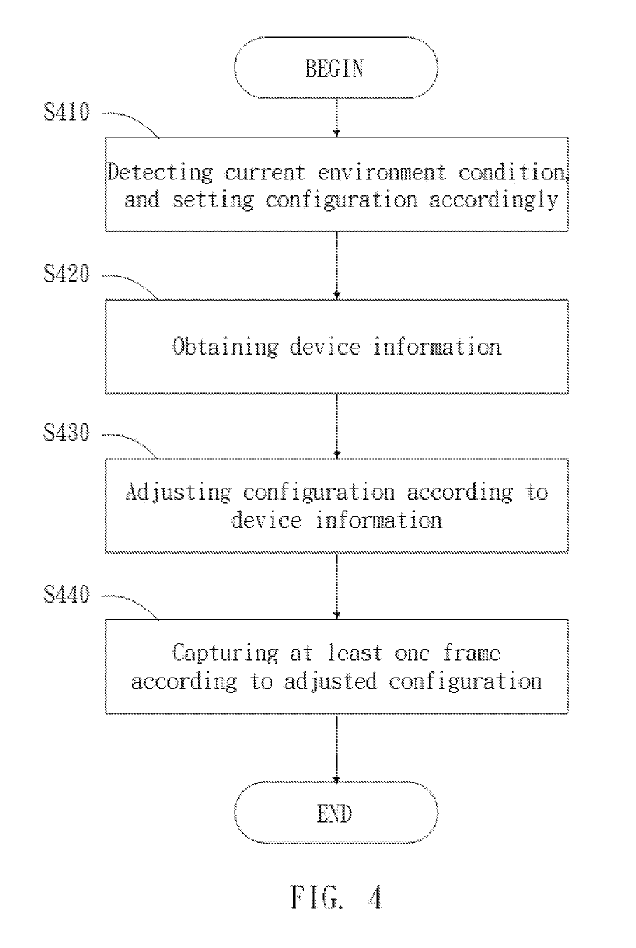

FIG. 4 is a flowchart of another embodiment of a method for capturing frames based on device information of the invention. The method for capturing frames based on device information can be used in an electronic device, such as a computer, or a portable device, such as a digital camera, a handheld device such as a mobile phone, a smart phone, a PDA, a GPS, or any picture-taking device. In the embodiment, the configuration is set according to the environment condition and the device information.

In step S410, a current environment condition is detected, and a configuration of an image capture unit is set according to the current environment condition. Similarly, in some embodiments, the configuration can comprise settings for a gain value, an exposure value, a shutter value, an aperture value, a white balance, an ISO value, an optical or digital zoom effect, a timing for capturing, and/or a delay period for capturing. It is noted that, the above configurations are only examples of the present application, and the present invention is not limited thereto. Then, in step S420, device information is obtained from at least one component of an electronic device. Similarly, in some embodiments, the component can comprise a positioning unit, such as a GPS unit, a motion sensor, and/or a timer of the electronic device. It is noted that, the above components are only examples of the present application, and the present invention is not limited thereto. In step S430, the configuration for the image capture unit is adjusted according to the device information, to obtain at least one adjusted configurations. Then, in step S440, at least one frame is captured via the image capture unit according to the at least one adjusted configuration.

For example, when the motion sensor of the electronic device indicates that the electronic device is moving, the setting for the exposure value can be adjusted to a smaller value than that of the original configuration, and the image capture unit can capture at least one frame based on the adjusted exposure value. In another example, when the motion sensor of the electronic device indicates that the electronic device is moving, a timing for capturing can be triggered when the movement of the electronic device is less than a first threshold. Once the movement of the electronic device is less than the first threshold, the image capture unit can capture at least one frame. In another example, when the motion sensor of the electronic device indicates that the electronic device is moving, and the movement of the electronic device is greater than a second threshold, a delay period for capturing can be set, and the image capture unit can capture at least one frame after the delay period passes.

In an example, when a user is taking a picture, especially in selfie (self-shooting), and the motion sensor detects that the electronic device is moving, the setting for the optical or digital zoom effect can be adjusted according to the movement of the electronic device. It is noted that, in some cases, when a specific instruction is received, the motion sensor starts to detect the movement of the electronic device. It is noted that, in some cases, only the motion sensor indicates that the electronic device is in a landscape mode, the adjustment for the optical or digital zoom effect is performed. For example, the electronic device can be moved along a specific axis of the electronic device, such that the setting for the optical or digital zoom effect can be accordingly adjusted. In some cases, when the electronic device moves away from the user, the zoom out effect is performed, and the image capture unit captures at least one frame accordingly. When the electronic device moves close to the user, the zoom in effect is performed, and the image capture unit captures at least one frame accordingly. It is noted that, the level of zoom out/in effect can be directly proportional to the movement distance of the electronic device.

In a further example, when the electronic is at outside of a building, which is determined according to the GPS information, and the time is night, which is determined according to the timer information, the gain value and the exposure value in the configuration can be accordingly adjusted, and the image capture unit can capture multiple frames based on the adjusted configurations. After frames corresponding to various configurations are captured, the multiple frames can be combined to have an image having a better quality. In some cases, the pixels which are clear in the respective frames can be combined to obtain an image. In some cases, the methods for combining frames can be similar to that of HDR (High Dynamic Range) technology.

Therefore, the methods and systems for capturing frames based on device information of the present invention can adjust the configuration for an image capture unit according to device information of an electronic device, and capture at least one frame according to the adjusted configuration, thus enhancing the deficiency of traditional cameras, and improving the quality of captured image frames.

Methods for capturing frames based on device information, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

1. A method for capturing frames based on device information for use in an electronic device, comprising:
detecting a current environment condition by an image capture unit
determining a configuration of the image capture unit according to the current environment condition;
obtain device information from at least one component of the electronic device, wherein the device information is a moving distance of the electronic device;
adjusting a level of zoom effect of the configuration according to the device information, to obtain at least one adjusted configuration, wherein the level of zoom effect is proportional to the moving distance; and
capturing at least one frame via the image capture unit according to the at least one adjusted configuration.

2. The method of claim 1, further combining the at least one frame to obtain an image.

3. The method of claim 1, wherein the component comprises a positioning unit, a motion sensor, or a timer of the electronic device.

4. The method of claim 1, wherein the configuration comprises settings for a gain value, an exposure value, a shutter value, an aperture value, a white balance, an ISO value, a timing for capturing, or a delay period for capturing.

5. (canceled)

6. A system for capturing frames based on device information for use in an electronic device, comprising:
at least one component of the electronic device;
an image capture unit detecting a current environment condition and setting configuration according to the current environment condition; and
a processing unit obtaining device information from the at least one component of the electronic device, the device information being a moving distance of the electronic device,
wherein the processing unit is further configured for adjusting a level of zoom effect of the configuration according to the device information to obtain at least one adjusted configuration, the level of zoom effect being proportional to the moving distance, and
wherein the processing unit is further configured for enabling the image capture unit to capture at least one frame according to the at least one adjusted configuration.

7. The system of claim 6, wherein the processing unit further combines the at least one frame to obtain an image.

8. The system of claim 6, wherein the component comprises a positioning unit, a motion sensor, or a timer of the electronic device.

9. The system of claim 6, wherein the configuration comprises settings for a gain value, an exposure value, a shutter value, an aperture value, a white balance, an ISO value, a timing for capturing, or a delay period for capturing.

10. (canceled)

11. A non-transitory machine-readable storage medium comprising a computer program, which, when executed, causes a device to perform a method for capturing frames based on device information, wherein the method comprises:
detecting a current environment condition by an image capture unit
determining a configuration of the image capture unit according to the current environment condition;
obtain device information from at least one component of the electronic device, wherein the device information is a moving distance of the electronic device;
adjusting a level of zoom effect of the configuration according to the device information, to obtain at least one adjusted configuration, wherein the level of zoom effect is proportional to the moving distance; and
capturing at least one frame via the image capture unit according to the at least one adjusted configuration.
